(19) United States
(12) Patent Application Publication
(10) Pub. No.: US 2005/0111395 A1
(43) Pub. Date: May 26, 2005

(54) Method for paging user equipment over dedicated channel in mobile communication system for supporting multimedia broadcast/multicast service MBMS

(75) Inventors: Sung-Oh Hwang, Yongin-si (KR); Kook-Heui Lee, Yongin-si (KR); Sung-Ho Choi, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/924,328

(22) Filed: Aug. 23, 2004

(30) Foreign Application Priority Data
Aug. 22, 2003 (KR) 2003-58427

(51) Int. Cl. H04Q 7/00

(52) U.S. Cl. 370/313; 370/329

(57) ABSTRACT

A method for paging a UE (User Equipment) over a dedicated channel in a mobile communication system for supporting a Multimedia Broadcast/Multicast Service (MBMS). The paging method can indicate the presence or absence of control information associated with the MBMS during a call-connection mode established over a dedicated channel in a Code Division Multiple Access (CDMA) communication system. If a Serving Radio Network Controller (SRNC) for supporting the MBMS recognizes the beginning of the MBMS in which the UE is joined, it requests from a transmission mode needed for the MBMS from one or more CRNCs (Control Radio Network Controllers) controlling a plurality of cells communicating with the UE, such that it acquires MBMS control channel (MCCH) information including control information for supporting the MBMS. Then, the SRNC transmits a paging message including the MCCH information to the UE over a dedicated channel.

### BACKGROUND OF THE INVENTION

1. Field of the Invention

The present invention relates to an MBMS (Multimedia Broadcast/Multicast Service) for use in a mobile communication system, and more particularly to a paging method for indicating the presence or absence of control information of an MBMS over a dedicated channel.

2. Description of the Related Art

With the increasing development of communication technologies, a conventional CDMA (Code Division Multiple Access) mobile communication system has been rapidly changed to a packet service communication system capable of transferring a large amount of data, for example, voice data, packet data, and circuit data, etc., and has also been changed to a multimedia communication system or multimedia broadcast communication system capable of transferring multimedia services. Therefore, there has been newly developed an MBMS capable of multicasting a service from one or more data sources to a plurality of UEs (User Equipments) so as to support the multimedia broadcast communication system.

The MBMS supports a variety of multimedia transmission data, for example, real-time video and audio data, still images, and text data, etc., simultaneously provides audio and video data according to applications of the multimedia transmission data, and requests a large amount of transmission resources. A plurality of UEs may be used for the same service, such that the MBMS may also be provided to the UEs over a broadcast channel.

The MBMS can perform a Point-to-Point (PtP) transmission mode for providing UEs with their desired MBMSs and a Point to Multi-point (PtM) transmission mode for providing the UEs with the same MBMS data requested by the UEs. In this case, according to the number of UEs requesting to receive the MBMS data associated with one MBMS or transmission power of a network capable of supporting the MBMS, the PtP and PtM transmission modes are differently selected according to individual cells.

In order to provide the MBMS, control information associated with the MBMS must be transferred to UEs requesting to receive the MBMS. For transmission of the control information, a paging operation must first be performed to indicate the presence or absence of the control information.

FIG. 1 is a conceptual diagram illustrating a process for controlling a UE to receive a dedicated service from a plurality of cells in a typical mobile communication system.

Referring to FIG. 1, the UE 150 does not receive the MBMS while participating in the MBMS, and receives a voice service or other dedicated services from an A cell 100, a B cell 110, and a C cell 120 over a dedicated channel (DCH). In this case, a specific area in which the cells 100, 110, and 120 can communicate with the UE is called a soft handover area.

In the case of initiating the MBMS, RNCs (Radio Network Controllers) for managing respective cells indicate the beginning of the MBMS in the respective cells, determine whether the MBMS is to be carried out by the PtP service or the PtM service, transmit information of a transmission channel of the MBMS over an MCCH (MBMS Control Channel), and transmit the MBMS data.

In this case, the UE 150 can receive the MBMS from the cells 100, 110, and 120. If the MBMS is performed in the PtM mode after the UE 150 receives a message indicative of the beginning of the MBMS, it is impossible for the UE 150 to determine which one of the cells 100, 110, and 120 will transmit the MBMS to the UE 150. Therefore, the UE 150 receives all the MCCHs transferred from the cells 100, 110, and 120, and receives the MBMS from the cells 100, 110, and 120 through MBMS Radio Bearer (RB) information received over the MCCHs. In this case, the RB (Radio Bearer) is indicative of a wired/wireless connection path between a UTRAN and the UE 150.

If the cells 100, 110, and 120 decide to transmit the MBMS using different transmission modes, for example, if the A cell 100 decides to transmit the MBMS using the PtP transmission mode, and the remaining cells 110 and 120 decide to transmit the MBMS using the PtM transmission mode, the UE 150 may repeatedly receive the same MBMS transferred from different cells in different modes, or the cells 100, 110, and 120 may repeatedly transmit unnecessary MBMSs to the same UE.

### SUMMARY OF THE INVENTION

Therefore, the present invention has been made in view of the above problems, and it is an object of the present invention to provide a method for informing a UE communicating with a plurality of cells of the presence or absence of control information associated with an MBMS in a mobile communication system for supporting the MBMS.

It is another object of the present invention to provide a method for using a paging message indicative of the presence or absence of MBMS-associated control information.

It is yet another object of the present invention to provide a method for controlling a UE communicating with a plurality of cells to effectively receive an MBMS in a mobile communication system for supporting the MBMS.

It is yet another object of the present invention to provide a method for controlling an RNC managing a UE communicating with a plurality of cells to inform the UE of the best cell suitable for MBMS reception in a mobile communication system for supporting the MBMS.

It is yet another object of the present invention to provide a method for controlling an RNC managing a UE communicating with a plurality of cells to perform signalling with other RNCs managing the plurality of cells in a mobile communication system for supporting the MBMS, such that the other RNCs determine an MBMS transmission mode in consideration of the UE, and perform management for the transmission mode.

It is yet another object of the present invention to provide a method for controlling an RNC managing a UE communicating with a plurality of cells to perform signalling with other RNCs managing the plurality of cells in a mobile communication system for supporting the MBMS, such that it transmits MCCH information transferred from a specific cell among the plurality of cells to the UE, and the UE can easily acquire MBMS-associated control information.

It is yet another object of the present invention to provide a method for controlling a UE in a CELL_FACH state to perform a paging operation requested by an UTRAN in a mobile communication system for supporting the MBMS.

In accordance with one aspect of the present invention, the above and other objects can be accomplished by the provision of a method for paging a User Equipment (UE) in a mobile communication system for supporting an MBMS (Multimedia Broadcast/Multicast Service), comprising the steps of: requesting a transmission mode in response to the MBMS from at least one CRNC (Control Radio Network Controller) controlling a plurality of cells communicating with the UE, when an SRNC (Serving Radio Network Controller) for supporting the MBMS recognizes the beginning of the MBMS in which the UE is joined; receiving MCCH (MBMS control channel) information including control information adapted to support the MBMS according to the requested result; and transmitting a paging message including the MCCH information to the UE over a dedicated channel (DCH).

In accordance with another aspect of the present invention, there is provided a method for controlling an SRNC (Serving Radio Network Controller) providing an MBMS (Multimedia Broadcast/Multicast Service) to page a User Equipment (UE) in a mobile communication system for supporting the MBMS, comprising the steps of: requesting a transmission mode in response to the MBMS from at least one CRNC (Control Radio Network Controller) controlling a plurality of cells communicating with the UE, when the SRNC recognizes the beginning of the MBMS; receiving response messages including information of a transmission mode in response to the MBMS from the CRNCs; and transmitting a paging message including control information of a control channel adapted to receive the MCCH to the UE over a dedicated channel (DCH) in consideration of the response messages.

In accordance with yet another aspect of the present invention, there is provided a method for allowing a CRNC (Control Radio Network Controller) controlling a cell communicating with a User Equipment (UE) to support the MBMS in a mobile communication system for supporting an MBMS (Multimedia Broadcast/Multicast Service), comprising the steps of: receiving a message requesting a transmission mode in response to the MBMS from an SRNC (Serving Radio Network Controller) supporting the MBMS when the CRNC recognizes the beginning of the MBMS; determining a transmission mode in response to the MBMS; and including control channel information including RB (Radio Bearer) information supporting the MBMS in a response message associated with the request message according to the determined transmission mode, and transmitting the response message including the control channel information.

In accordance with yet another aspect of the present invention, there is provided a method for paging a User Equipment (UE) to receive an MBMS (Multimedia Broadcast/Multicast Service) in a mobile communication system for supporting the MBMS, comprising the steps of: receiving a message including an MBMS ID (Identifier) indicative of the beginning of the MBMS; and checking the received message, and receiving the MBMS in a cell having a cell ID using the cell ID included in a paging message when the checked message is equal to the paging message further including control channel information adapted to support the MBMS.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a conceptual diagram illustrating a process for controlling a UE to receive a dedicated service from a plurality of cells in a typical mobile communication system;

FIG. 2 is a block diagram illustrating a mobile communication system for supporting the MBMS;

FIG. 3 is a block diagram illustrating a UTRAN in a mobile communication system for supporting in the MBMS;

FIG. 4 is a block diagram illustrating a hierarchical structure of the UTRAN in a mobile communication system;

FIG. 5 is a view illustrating a configuration of a third paging message for paging the UE in accordance with a preferred embodiment of the present invention;

FIG. 6 is a flow chart illustrating a paging method of the UE over a dedicated channel in accordance with a preferred embodiment of the present invention;

FIG. 7 is a flow chart illustrating operations of an SRNC in accordance with a preferred embodiment of the present invention;

FIG. 8 is a flow chart illustrating operations of a CRNC in accordance with a preferred embodiment of the present invention; and

FIG. 9 is a flow chart illustrating operations of the UE in accordance with a preferred embodiment of the present invention.

### DETAILED DESCRIPTION OF THE PREFERRED EMBODIMENTS

Now, preferred embodiments of the present invention will be described in detail with reference to the annexed drawings. In the drawings, the same or similar elements are denoted by the same reference numerals even though they are depicted in different drawings. In the following, a detailed description of known functions and configurations incorporated herein will be omitted when it may make the subject matter of the present invention rather unclear.

The present invention controls a UE communicating with a plurality of cells in a mobile communication system for providing an MBMS to effectively receive MBMS-associated control information, determines the presence or absence of the MBMS-associated control information, and determines a cell to which the MBMS-associated control information is transmitted.

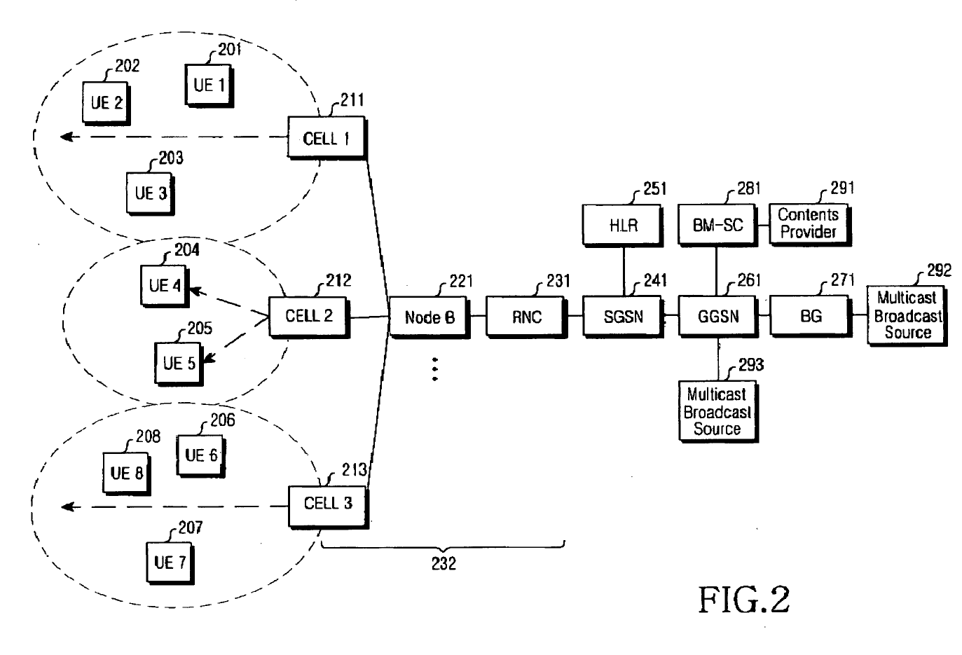

FIG. 2 is a block diagram illustrating a system for providing the MBMS in the 3GPP (3rd Generation Partnership Project) indicative of the 3rd-generation asynchronous mobile communication system standard.

Referring to FIG. 2, the system includes a UTRAN (UMTS Terrestrial Radio Access Network), which is composed of a plurality of UEs 201˜208, a Node B 221, and an RNC (Radio Network Controller) 231, an SGSN (Serving General Packet Radio Service Support Node) 241 acting as a CN (Core Network), an HLR (Home Location Register) 251, a GGSN (Gateway General Packet Radio Service Support Node) 261, a BM-SC (Broadcast/Multicast Service Center) 281, a CP (Contents Provider) 291, and a BG 271.

Individual functions of the aforementioned components for use in the MBMS may be differently determined by a network administrator, and their detailed description will hereinafter be given.

The UEs 201˜208 receive MBMS data, and provide a user with a corresponding MBMS. The UTRAN 232 transmits the MBMS data to UEs 201˜208, receives a request message for MBMS reception from the UEs 201˜208, and transmits the request message to the CN.

The SGSN 241 receives data associated with a UE requesting the MBMS from the HLR 251, authenticates the received data, receives authority of the MBMS requested by the UE from the HLR 251, authenticates the received MBMS authority, establishes an RAB for the MBMS requested by the UE, and supports the MBMS reception when the UE moves to another location in a corresponding cell. The SGSN 241 is connected to corresponding MBMS broadcast sources 292 and 293 over the GGSN 261, and collects settlement information for the MBMS used by the UE.

The HLR 251 manages authentication information of each registered UE and contents associated with the MBMS usable by the corresponding UE. The GGSN 261 receives MBMS data to be transmitted to the UE from the BM-SC 281, transmits the received MBMS data to the SGSN 241, and collects settlement information of the UE. The GGSN 261 manages mobility of a plurality of UEs, and also manages a QoS (Quality of Service) of the MBMS supplied to the UE.

The BM-SC 281 performs contents-user authentication and settlement information management, determines a QoS of the MBMS, performs error correction for lost MBMS data, transmits MBMS data received from the Contents Provider (CP) 291 to the GGSN 261, and notifies a currently-served MBMS. The CP 291 provides the BM-SC 281 with the MBMS contents.

The BM-SC 281 acts as sources for providing an MBMS data stream, schedules the MBMS-associated stream, and transmits the scheduled result to the GGSN 261. The GGSN 261 transmits the MBMS-associated stream from the BM-SC 281 to the SGSN 241. In this case, the SGSN 261 is included in the CN, and is adapted to connect the UTRAN 232 with the CN. For example, provided that there are a plurality of UEs who desire to receive the MBMS at a specific time, the SGSN 241 having received the MBMS stream at the GGSN 261 controls MBMS-associated services of the UEs indicative of subscribers who desire to receive the MBMS.

For example, the SGSN 241 manages settlement data of the MBMS of each subscriber, and selectively transmits the MBMS data to a specific RNC 231, such that it controls the MBMS-associated data. The SGSN 241 configures and manages the SGSN service context associated with a specific MBMS, and retransmits the MBMS-associated stream to the RNC 231. In this case, the MBMS context is indicative of the set of control information required to provide a predetermined MBMS.

The RNC 231 controls a plurality of Node Bs, transmits the MBMS data to the Node B 221 having a UE requesting the MBMS from among the Node Bs, controls a radio channel to provide the MBMS, and configures/manages an RNC service context associated with the MBMS using the received MBMS-associated stream. In this case, the HLR 251 is connected to the SGSN 241, and performs subscriber authentication for the MBMS.

As described above, the RNC and the SGSN manage information associated with individual MBMSs. In this case, information stored in the MBMS context includes name information of UEs requesting the MBMS (i.e., ID information of UEs who desire to receive the MBMS), information of a service area including the UEs, and QoS information required to provide the MBMS, etc.

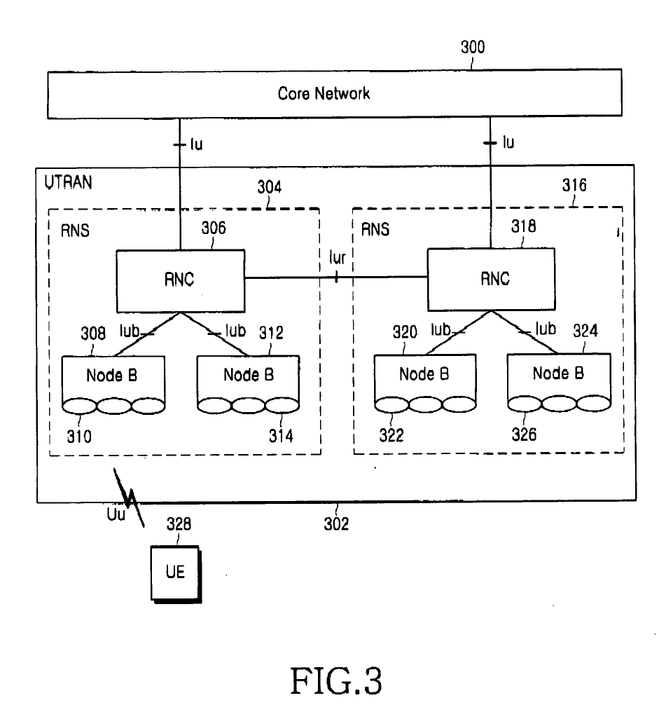

FIG. 3 is a detailed block diagram illustrating the UTRAN 232 for use in a mobile communication system for supporting the MBMS.

Referring to FIG. 3, the UE 328 directly receives a corresponding MBMS, and includes hardware or software capable of supporting the MBMS. The UTRAN 302 is indicative of a wireless communication network for connecting the UE 228 to the CN 300. The UTRAN 302 includes a plurality of RNSs (Radio Network Systems) 304 and 316. Each of the RNSs 304 and 316 is comprised of a plurality of RNCs 306 and 318, a plurality of Node Bs 308, 312, 320, and 324 controlled by the RNCs 306 and 318, and a plurality of cells 310, 314, 322, and 326 contained in the Node Bs 308, 312, 320, and 324, respectively.

The RNS 304 includes Node Bs 308 and 312 controlled by the RNC 306 and a plurality of cells 310 and 314 controlled by the Node Bs 308 and 312. The RNS 316 includes Node Bs 320 and 324 controlled by the RNC 318 and a plurality of cells 322 and 326 controlled by the Node Bs 320 and 324. The number of Node Bs 308, 312, 320, and 324 controlled by the RNCs 306 and 318, and the number of cells 310, 314, 322, and 326 contained in individual Node Bs 308, 312, 320, and 324 are determined by a service provider, and individual performances of the RNCs 306 and 318 and the Node Bs 308, 312, 320, and 324.

The UE 328 and the UTRAN 302 are interconnected over a Uu interface. The UTRAN 302 is connected to the CN 300 over an Iu interface. In FIG. 2, the SGSN 241 and the HLR 251 are interconnected over a Gr interface, the SGSN 241 and the GGSN 261 are interconnected over a Gn/Gp interface. The GGSN 261 and the BM-SC 281 are interconnected over a Gi interface. The BM-SC 381 and the CP 291 are interconnected over a Gn/Gp interface.

In association with the aforementioned description of FIG. 3, an upper layer configuration of the UTRAN defined in the 3GPP and channels between individual layers will hereinafter be described.

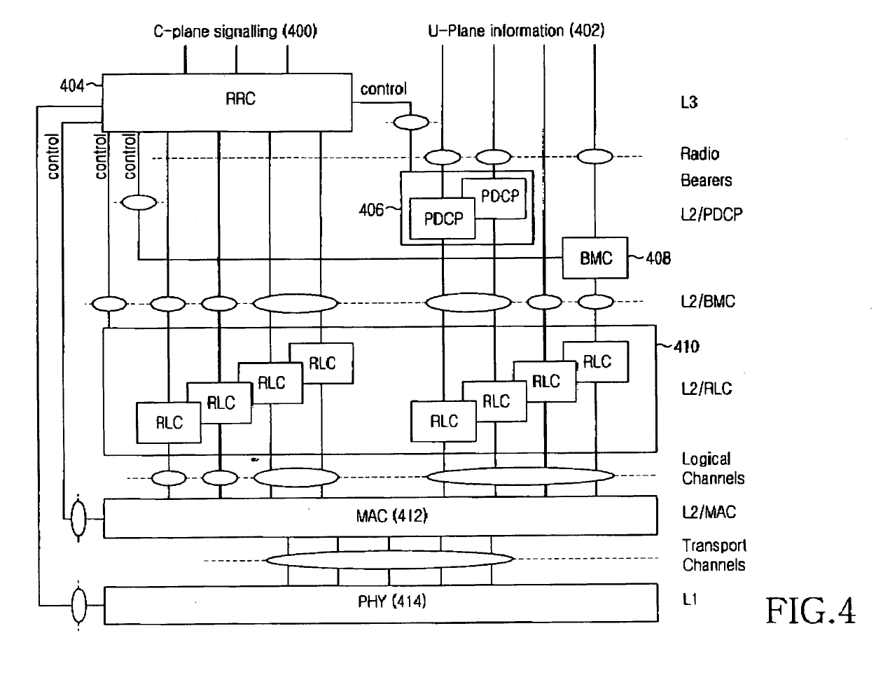

FIG. 4 is a block diagram illustrating a hierarchical structure of a UTRAN protocol for the Uu interface. Referring to FIG. 4, upper layer messages processed by the UTRAN can be classified into control signaling data and user data.

The UTRAN protocol is generally comprised of a Control Plane (C-Plane) 400 and a User Plane (U-Plane) 402. The C-Plane 400 and the U-Plane 402 are adapted to process NAS (Non Access Stratum) messages. The NAS messages are indicative of messages unused in wireless access between the UE and the UTRAN, and are equal to messages whose contents need not be recognized by the UTRAN. Differently from the NAS, messages directly used for wireless access between the UTRAN and the UE are called AS (Access Stratum) messages, and are indicative of either data or control signal used below the RRC (Radio Resource Control) layer 404 of FIG. 4.

The RRC 404 controls a Physical Layer (L1) 414 associated with the access between the UE and the UTRAN, a Medium Access Control (L2/MAC) 412 of the layer 2, a Radio Link Control (L2/RLC) 410, a Packet Data Convergency Protocol (L2/PDCP) 406, and a Broadcast/Multicast Control (L2/BMC) 408. Therefore, the RRC 404 controls all the functions associated with the access between the UE and the UTRAN, for example, a physical call setup function, a logical call setup function, a control information transmission/reception function, and a specific data transmission/reception function, etc.

The L2/PDCP 406 receives data to be received from the upper NAS layer, and transmits the received data to the L2/RLC 410 using an appropriate protocol. The L2/BMC 408 receives data required for broadcast/multicast from the NAS layer, and transmits the received data to the L2/RLC 410 using a proper protocol.

The L2/RLC 410 receives a control message transmitted from the RRC 404 to the UE, properly processes the received control message in one of RLC#1˜RLC#n in consideration of characteristics of the control message, and transmits the processed result to the L2/MAC 412 over a logical channel. The L2/RLC 410 receives data from the L2/PDCP 406 and the L2/BMC 408, properly processes the received data in one of RLC#1˜RLC#n, and transmits the processed result to the L2/MAC 412 over a logical channel. The number of RLC elements used in the L2/RLC 410 is determined by the number of radio links between the UE and the UTRAN.

The logical channel is determined to be a dedicated-type logical channel when it is associated with a specific UE, and is determined to be a common-type logical channel when it is associated with a plurality of UEs. If information loaded on a transmission message is indicative of data associated with control information, the logical channel is determined to be a control-type logical channel. If information loaded on a transmission message is indicative of data associated with traffic information, the logical channel is determined to be a traffic-type logical channel.

In association with the aforementioned description, categories and functions of a variety of logical channels used in the 3GPP will hereinafter be described.

BCCH (Broadcast Control Channel) is used for downlink transmission from the UTRAN to the UE, and is used for transmission of the UTRAN system control information. PCCH (Paging Control Channel) is used for downlink transmission from the UTRAN to UE, and is adapted to page the UE. CCCH (Common Control Channel) is used for transmission of PtM (Point-to-Multipoint) control information generated between the UE and a network, and transmits data over a common transport channel. DCCH (Dedicated Control Channel) is used for transmission of PtP (Point-to-Point) control information generated between the UE and the network, and transmits data over a common transport channel or a dedicated transport channel. CTCH (Common Transport Channel) is used for transmission of PtM data generated between the network and the UEs, and transmits data over a dedicated transport channel. DTCH (Dedicated Transport Channel) is used for transmission of PtP data generated between the network and the UE, and transmits data over a common transport channel or a dedicated transport channel.

The L2/MAC 412 manages radio resources generated between the UE and UTRAN upon receiving a control signal from the RRC 404, such that it manages the access between the UE and the UTRAN. Therefore, the L2/MAC 412 receives information of corresponding logical channels from the L2/RLC 410, maps the received information to corresponding transport channels, and transmits the mapped result to the physical layer 414. Names and functions of the transport channels will hereinafter be described.

BCH (Broadcast Channel) is mapped to BCCH, such that it transmits data of the BCCH. PCH (Paging Channel) is mapped to PCCH, such that it transmits data of the PCCH. RACH (Radio Access Channel) is used for data transmission from the UE to the network, and is adapted to transmit network access data, control messages, and short data. The RACH can be mapped to DCCH, CCCH, and DTCH. FACH (Forward Access Channel) transmits control information messages or data from the network to a specific UE or specific UEs. The FACH can be mapped to BCCH, CTCH, CCCH, DCTH, and a DCCH. DCH (Dedicated CHannel) is a channel for transmitting data and control information messages from the network to the UE, and is mapped to DCCH and DTCH. DSCH (Downlink Shared Channel) is a downlink channel from the network adapted for transmission of large amounts of data to the UE, and is mapped to DTCH and DCCH. HS-DSCH (High Speed DSCH) is a downlink channel from the network having improved transmission efficiency of the DSCH to the UE, and is mapped to DTCH and DCCH.

Furthermore, other transport channels, i.e., an Uplink Shared Channel and a Common Packet Channel, may also be adapted as such transport channels.

Transport channel data transmitted to the physical layer 414 is encoded and modulated, and corresponds to physical channel data, such that the physical channel data is transmitted to the UE or the UTRAN. The physical channels are comprised of a Primary Common Control Physical Channel (P-CCPCH) for transmitting BCH data, a Secondary Common Control Synchronization Channel (S-CCSCH) for transmitting PCH (Paging Channel) and FACH (Forward Access Channel) data, a Paging Indicator CHannel (PICH), an Acquisition Indicator Channel), and a Physical Common Packet Channel, etc.

A method for processing the MBMS based on the aforementioned system will hereinafter be described.

The UTRAN transmits basic information and service guide information associated with the MBMS to a plurality of UEs. If the UEs having received the basic and service guide information associated with the MBMS desire to receive the MBMS, they are registered in the CN. This registration process is called a joining process. Thereafter, name information of the UEs including the UE having requested the MBMS is transmitted to the CN (e.g., BM-SC and SGSN) and the UTRAN.

After the CN and its UTRAN receive the name information of the UEs having requested the MBMS, they transmit a paging message to a plurality of UEs, and establish a Radio Bearer (RB) for providing the MBMS. The CN provides a corresponding UE with a corresponding MBMS over the established RB. If the MBMS is terminated, the MBMS termination information must be transferred to all the UEs. Therefore, the CN and UTRAN managing the UEs release radio resources assigned for the MBMS, such that the MBMS is terminated.

In the case of the aforementioned MBMS procedures, the beginning of the MBMS indicates that control information indicative of the MBMS beginning is transmitted. There are two paging methods for indicating that the control information indicative of the MBMS beginning is transmitted. A first paging method is indicative of a method using a common channel. In more detail, the first paging method is performed using the aforementioned PICH/PCH. A second paging method is indicative of a method using a dedicated channel. In more detail, the second paging method is performed using the DCCH.

Five operation modes of the UE according to access channels of the UE are defined in the 3GPP. In this case, the five operation modes are an idle mode, a URA_PCH mode, a CELL_PCH mode, a CELL_FACH mode, and a CELL_DCH mode. One of the first and second methods is selectively determined according to individual modes. Detailed descriptions of the five operation modes of the UE will hereinafter be described.

The idle mode indicates a specific condition in which there is no RRC connection between the UE and the UTRAN. During the idle mode, upon receiving a Descript Reception Parameter defined by the CN, the UE determines whether there is a signal received from the CN or UTRAN.

The URA_PCH (UTRAN Registration Area Paging Channel) mode indicates a specific condition in which there is an RRC connection between the UE and the UTRAN and the UE's position is recognized in URA units. During the URA_PCH mode, upon receiving a Descript Reception Parameter defined by the UTRAN, the UE determines whether there is a signal received from the CN or UTRAN. The URA is indicative of the set of a plurality of cells.

The CELL_PCH (CELL Paging CHannel) mode indicates a specific condition in which there is RRC connection between the UE and the UTRAN and the UE's position is recognized in cell units. During the CELL_PCH mode, upon receiving a Descript Reception Parameter defined by the UTRAN, the UE determines whether there is a signal received from the CN or UTRAN.

The CELL_FACH (CELL Forward Access Channel) mode indicates a specific condition in which there is RRC connection between the UE and the UTRAN and the UE's position is recognized in cell units. During the CELL_FACH mode, the UE receives the FACH signal from individual cells. The UE can determine the presence or absence of a signal received from the CN using a paging method over the DCCH.

The CELL_DCH (Cell Dedicated Channel) mode indicates a specific condition in which there is RRC connection between the UE and the UTRAN and the UE's position is recognized in cell units. During the CELL_DCH mode, the UE receives the DPCH signal from the cell, and at the same time uses a voice call or other dedicated packet services. Furthermore, the UE prevents unnecessary interference noise from being generated, and controls transmission/reception power for effective data transmission/reception. During the voice service, the UE can recognize the presence or absence of packet service using a paging function over the DCCH. During the packet service, the UE can recognize the presence or absence of the voice service using a paging function over the DCCH.

The three modes from among the above five modes of the UE, i.e., the idle mode, the URA_PCH mode, and the CELL_PCH mode, receive PICH data to increase the lifetime of the UE's battery, identify a Paging Indicator (PI) transmitted over the PICH, receive PCH data transmitted over the S-CCPCH, and determine whether the received PCH data is indicative of a paging signal received from the UE. In this manner, the aforementioned three modes use the first paging method using the common channel. The remaining two modes from among the above five modes of the UE, i.e., the CELL_FACH mode and the CELL_DCH mode use the second paging method because the UE currently communicates with the UTRAN/CN in the CELL_FACH or CELL_DCH mode, such that they indicate the beginning of the voice service over the dedicated channel (DCH) in the case of packet service reception and indicate the beginning of the packet service over the dedicated channel (DCH) in the case of voice service reception.

A paging message for use in the paging method indicative of the presence or absence of control information over the dedicated channel (DCH) in the 3GPP is called a Paging Type message 2. The Paging Type message 2 is adapted when a paging signal of the UE is received from the CN. In more detail, the UE receiving DCH data has already recognized position information from the viewpoint of the UTRAN and is also able to communicate with the UTRAN, such that the paging method using the DCH is used only when a new service from the CN begins.

If the UE includes radio links connected to a plurality of cells and is able to receive the MBMS from all the cells, the paging method using the DCH cannot be used due to the following reasons. In more detail, the paging method using the DCH is used for only a paging signal received from the CN, and allows MBMS data transferred from the UTRAN to the UE to be repeatedly received in the UE in different modes, such that the UEs may be repeatedly considered when the UTRAN determines a transmission mode of the MBMS. Also, the UEs each have a plurality of radio links, such that they do not know which one of the radio links will provide them with MBMS-associated control information.

In this manner, the UEs in the CELL_FACH mode cannot receive the remaining signals other than the paging signal generated from the CN when they use the paging method using the DCH. Therefore, if an MBMS-associated paging signal is generated by a request of the UTRAN, a method for paging the UEs currently in the CELL_FACH mode is required.

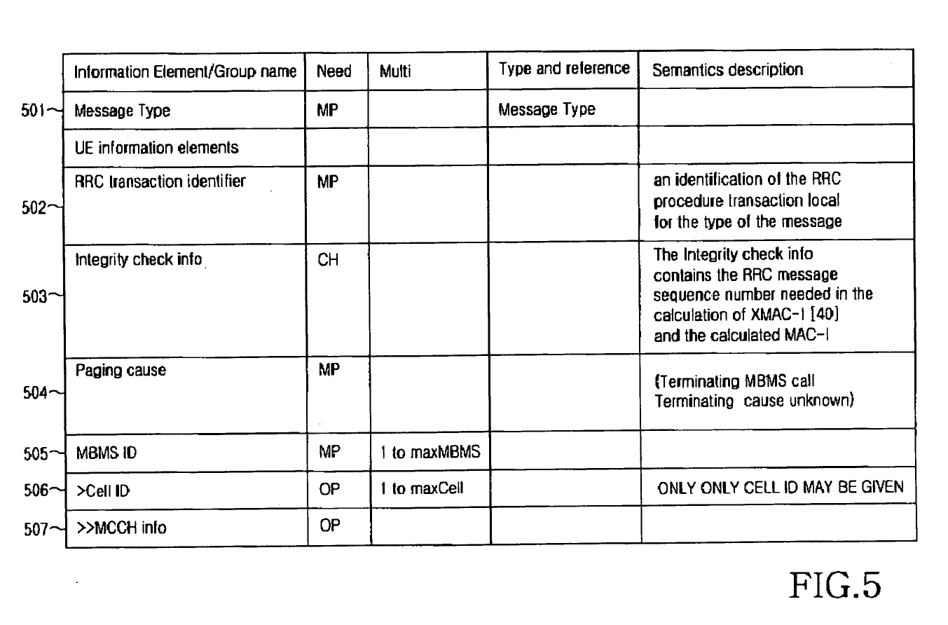

FIG. 5 is a view illustrating the format of a signaling message adapted to perform a paging operation over the DCH in accordance with a preferred embodiment of the present invention. The signaling message is called a Paging Type 3 message (also called a third paging-type message). Although only basic fields are shown in FIG. 5 for the convenience of description, it should be noted that other IEs (Information Elements) may also be further included in the signaling message according to requisitions defined in the 3GPP standard.

Referring to FIG. 5, the message type 501 is determined to be a unique value indicative of the third paging-type message. The RRC transaction ID (Identifier) 502 is indicative of version information of a control signal transferred from the RRC, and is used for a response message of the control signal transferred from the RRC. In the case of transmitting the same control messages, the RRC transaction ID 502 is adapted to classify individual control messages.

Integrity Check Info (Information) 503 is adapted to transmit parameters to be used for an integrity test determining whether the third paging-type message is received without any errors, and is not used when an integrity protection function is not used. Paging Cause 504 is equal to a value indicative of the MBMS paging in the present invention. The Paging Cause 504 can be replaced with an MBMS ID 505.

The MBMS ID 505 is indicative of an ID for identifying the MBMS. The third paging-type message may include a plurality of MBMS IDs. Although many categories of the MBMS ID 505 may be used, the MBMS ID 505 is defined as an ID for controlling the UE receiving the third paging-type message to identify each MBMS.

The third paging-type message further includes the cell ID 506 and MCCH information 507 in association with each MBMS ID 505. The cell ID 506 is indicative of an ID of a cell where the MBMS associated with the MBMS ID will be transmitted. The MCCH information 507 is used in a cell associated with the cell ID 506. In more detail, UEs having a plurality of radio links in the CELL_DCH mode each further include the cell ID 506 and the MCCH information 507. However, another UE having only one radio link in the CELL_DCH or CELL_FACH mode includes only the MBMS ID 505. In other words, if the UE uses only one radio link, it can receive the MCCH information using only the MBMS ID or can perform other MBMS-associated operation using only the MBMS ID, so that the UE having only one radio link in the CELL_DCH or CELL_FACH mode includes only the MBMS ID 505.

Basic IEs (Information Elements) required for the present invention in the third paging-type message are indicative of an MBMS ID, an ID of a cell, which will transmit or currently transmits the MBMS associated with the MBMS ID, and channel information receiving MCCH information from the cell associated with the cell ID.

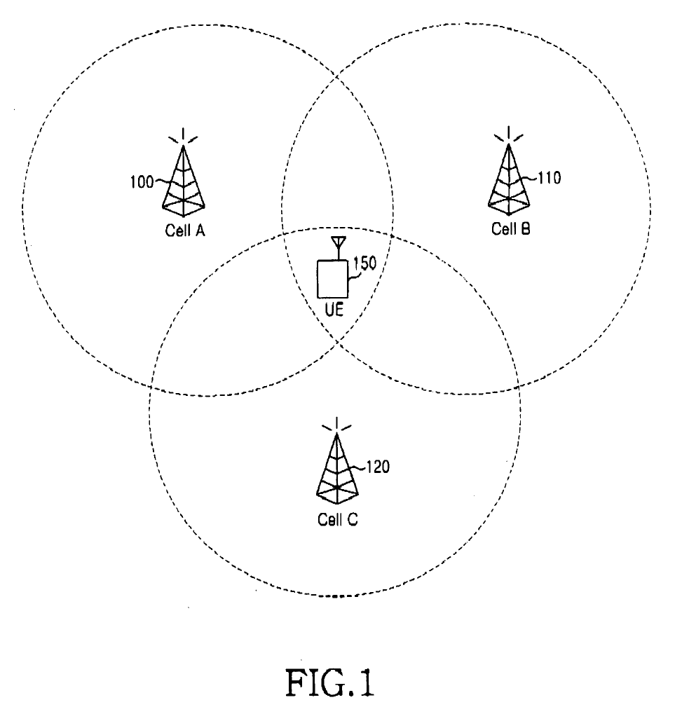

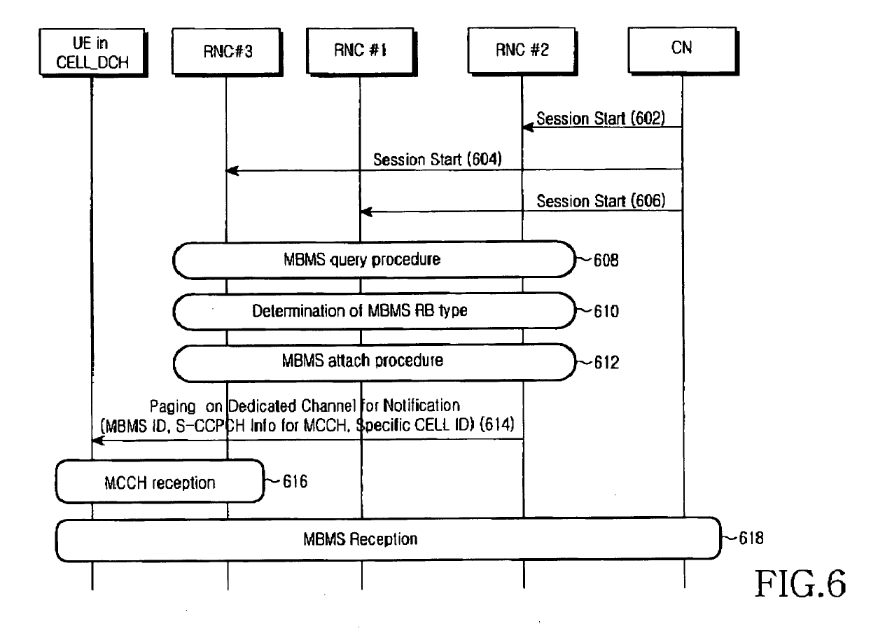

FIG. 6 is a flow chart illustrating a paging method of the UE over a dedicated channel in accordance with a preferred embodiment of the present invention. In this case, the UE connects its radio link to at least two cells as shown in FIG. 1, and exchanges a signaling message, which performs the MBMS associated with an SRNC (Serving RNC) and a CRNC (Control RNC) managing cells communicating with the UE, for others. The signaling message is equal to the third paging-type message.

In this case, the SRNC is indicative of an RNC in which the UE is registered, performs a variety of functions for the UE 601 (i.e., a position management function and a service management function), and provides a connection link between the UE and the CN. The CRNC is indicative of an RNC managing one or more cells communicating with the UE 601. One or more CRNCs may be used for the UE 601 whereas only one SRNC is used for the UE 601. In FIG. 6, RNC#2 is indicative of the SRNC associated with the UE, RNC#3 and RNC#1 are defined as the CRNCs associated with the UE.

Referring to FIG. 6, the CN transmits a Session Start message indicative of the MBMS beginning to each of the RNC#3, RNC#1, and RNC#2, respectively. In more detail, the session start message is transmitted to the RNC#2 at step 602, the session start message is transmitted to the RNC#3 at step 604, and the session start message is transmitted to the RNC#1 at step 606.

The RNC#2 having received the session start message of step 606 performs an MBMS query procedure at step 608. During the MBMS query procedure, the RNC#2 queries the RNC#3 and RNC#1 managing cells communicating with the UE of the CELL_DCH mode for specific information indicating which transmission mode will be adapted as the MBMS transmission mode. The MBMS query procedure 608 controls the UE not to receive the same MBMS in different transmission modes (e.g., PtP and PtM transmission modes) from all the cells, and controls CRNCs managing cells connected to the UE to inform the SRNC of specific information indicating which transmission mode can be adapted as the MBMS transmission mode. Therefore, the MBMS query procedure 608 can effectively transmit MBMS data to the UE without causing wasted radio resources.

After the RNC#2 receives the specific information indicating which transmission mode will be adapted as the MBMS transmission mode from the cells connected to the UE at step 608, it finally determines which transmission mode will be adapted as the MBMS transmission mode for the UE on the basis of the received information at step 610. Although the RNC#2 does not have direct authority capable of determining the MBMS transmission mode for the UE, it can recognize which transmission mode will be adapted as the MBMS transmission mode by the cells connected to the UE, such that the UE can finally determines whether it should receive the MBMS data in the PtP mode or the PtM mode. In this case, it is assumed that the RNC#2 transmits the MBMS to one of cells connected to the UE in the PtM transmission mode. The RNC#2 performs an MBMS attachment procedure on the basis of the determined transmission mode along with the RNC#3 acting as a CRNC for managing a cell which will transmit the MBMS to the UE in the PtM mode at step 612. The MBMS attachment procedure allows the RNC#3 to recognize specific information indicating that the LE ‘K’ receives the MBMS from the cell managed by the RNC#3. In more detail, the MBMS attachment procedure controls the UE receiving the MBMS to communicate with the RNC#2 acting as an SRNC receiving necessary control messages, and is applied to a method for determining transmission formats of the UE and the MBMS.

In this case, the UE does not receive broadcast channel data for transmitting system information of individual cells because it is in the CELL_DCH mode. Therefore, the UE cannot acquire MCCH information transmitted over broadcast channels of the above cells. The RNC#2 acquires MCCH information used in a cell at which the UE will receive the MBMS through either the MBMS query procedure 608 or the MBMS attachment procedure 612. The RNC#2 transmits various information to the UE using the third paging-type message at step 614, for example, information indicative of the beginning of the MBMS in which the UE is registered, information of a cell which will receive the MBMS, and channel information capable of acquiring control information required for MCCH reception.

If the UE receives the third paging-type message, it recognizes that the MBMS in which the UE is registered will begin soon at step 616, receives MCCH information from a cell commanded by the third paging-type message, prepares the MBMS reception, and receives MBMS data at step 618. In this case, the UE receives the MBMS data using MBMS RB information included in the MCCH information.

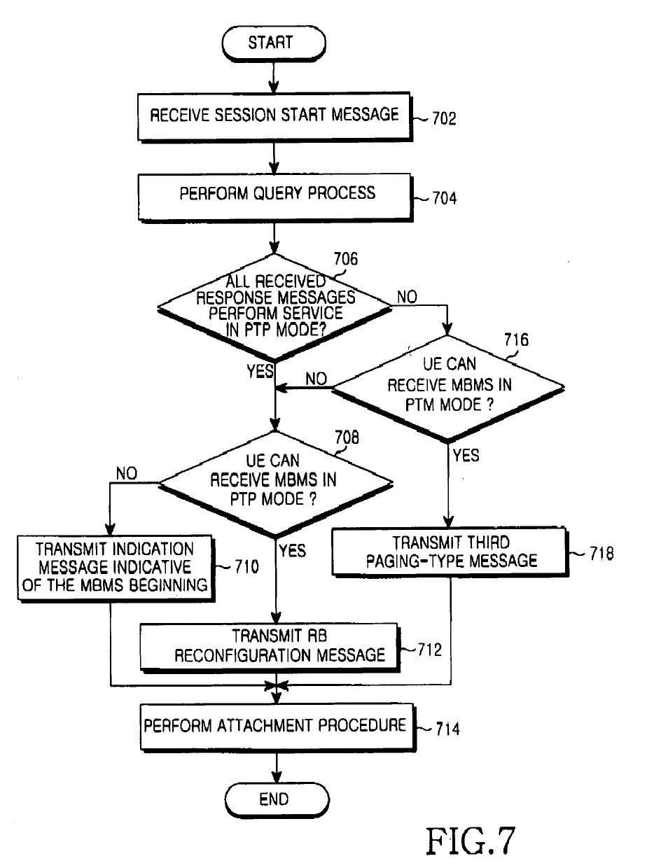

FIG. 7 is a flow chart illustrating operations of an SRNC in accordance with a preferred embodiment of the present invention. As shown in FIG. 7, in association with all the situations in which the LE in the CELL_DCH mode, the UE being registered in the SRNC, can receive the MBMS, the SRNC controls the UE to acquire the beginning of the MBMS and control information needed to receive the MBMS data.

Referring to FIG. 7, the SRNC receives a session start message from the CN at step 702, and controls CRNCs managing cells communicating with the UE to perform a query process indicating which transmission mode will be adapted as the MBMS transmission mode for the UE at step 704. In more detail, the SRNC queries CRNCs about specific information indicating whether the MBMS will be transmitted in the PtP transmission mode or the PtM transmission mode. In this case, the SRNC can receive MCCH control information to be transmitted as the third paging-type message.

The SRNC discriminates a first response message equal to a PtP-associated response message and a second response message equal to a PtM-associated response message from among a plurality of response messages received from the CRNCs at step 706. Upon receiving the first response message from each of all CRNCs, the SRNC refers to information associated with reception capability of other services different from the MBMS currently supplied to the UE, such that it can determine whether the UE has MBMS reception capability at step 708. The SRNC pre-recognizes capability of all UEs registered in the RNC, such that it can perform the discrimination process as in the above step 708.

If it is determined that the UE cannot further receive the MBMS at step 708, i.e., if the UE cannot receive current MBMS at step 708, the SRNC includes only the MBMS ID in the third paging-type message, and transmits the third paging-type message including the MBMS ID at step 710, such that it indicates the beginning of the MBMS. Therefore, the UE is able to request reception of the MBMS after terminating a current reception service.

In the meantime, if it is determined that the UE can receive the MBMS at step 708, the SRNC transmits an RB reconfiguration message to the UE at step 712, such that the UE can receive the MBMS. If it is determined that the UE cannot receive the current MBMS, the SRNC transmits the MBMS RB message in the same manner as in the above step 712, such that the UE can receive the MBMS at a later time.

The 3GPP can adjust a transmission time of data transmitted to individual transport channels using a transmission combination among the transport channels. Therefore, although the UE is unable to receive the current MBMS using the aforementioned functions, the UE may immediately receive the MBMS after the current service is terminated.

If one of the CRNCs receives the second response message equal to the PtM-associated response message, the SRNC determines whether the UE can receive the MBMS in the PtM transmission mode at step 716. If it is determined that the UE cannot receive the MBMS in the PtM transmission mode at step 716, the SRNC goes to step 708.

Otherwise, if it is determined that the UE can receive the MBMS in the PtM mode at step 716, the SRNC transmits a third paging-type message comprised of the MBMS ID, the cell ID, and the MCCH information to the UE over the CRNCs at step 718, and performs a UE-associated attachment process at step 714.

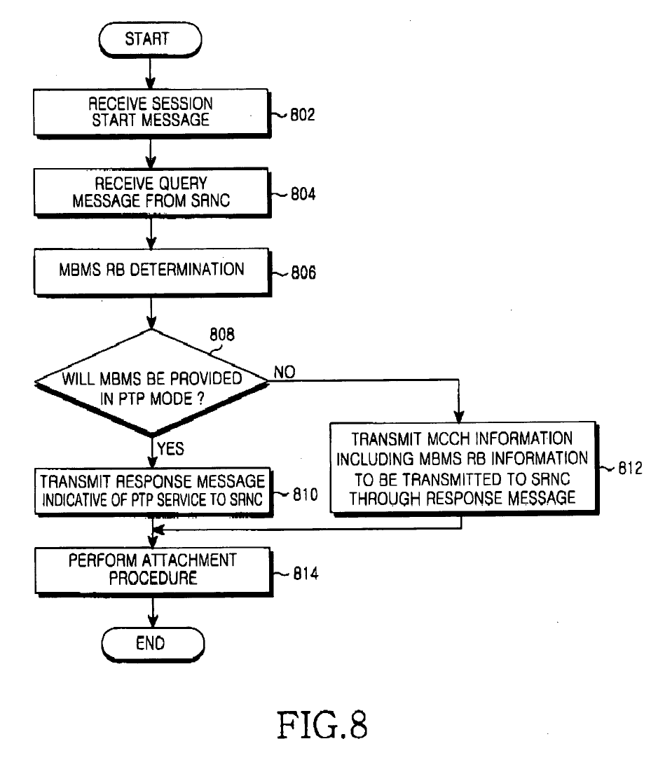

FIG. 8 is a flow chart illustrating operations of a CRNC in accordance with a preferred embodiment of the present invention. In FIG. 8, the CRNC is indicative of at least one RNC capable of managing a plurality of cells communicating with one UE, and manages communication of the UE through the SRNC.

Referring to FIG. 8, the CRNC receives a session start message at step 802, and receives a query message inquiring an MBMS transmission mode from an SRNC corresponding to the UE at step 804. In this case, the UE currently performs communication in the CELL_DCH mode in at least one cell managed by the CRNC. When providing the UE with the MBMS, the query message is adapted to determine whether the PtP transmission mode will be used as the MBMS transmission mode or the PtM transmission mode will be used as the MBMS transmission mode.

The CRNC determines an MBMS RB which will transmit the MBMS associated with a specific case including the UE at step 806, and determines whether the MBMS will be transmitted in the PtP transmission mode at step 808. If it is determined that the CRNC decides to perform the MBMS in the PtP transmission mode at step 808, the CRNC transmits a response message indicating that the MBMS will be transmitted in the PtP transmission mode to the SRNC at step 810. Otherwise, if it is determined that the CRNC decides to transmit the MBMS in the PtM transmission mode at step 808, the CRNC transmits a response message including control information associated with the MCCH over which the MBMS RB information will be transmitted, to the SRNC at step 812.

Thereafter, the CRNC receives the UE-associated attachment request from the SRNC and performs an attachment process at step 814. The CRNC transmits an MBMS start command message from the SRNC, the RB reconfiguration message, or the third paging-type message to the UE at step 814.

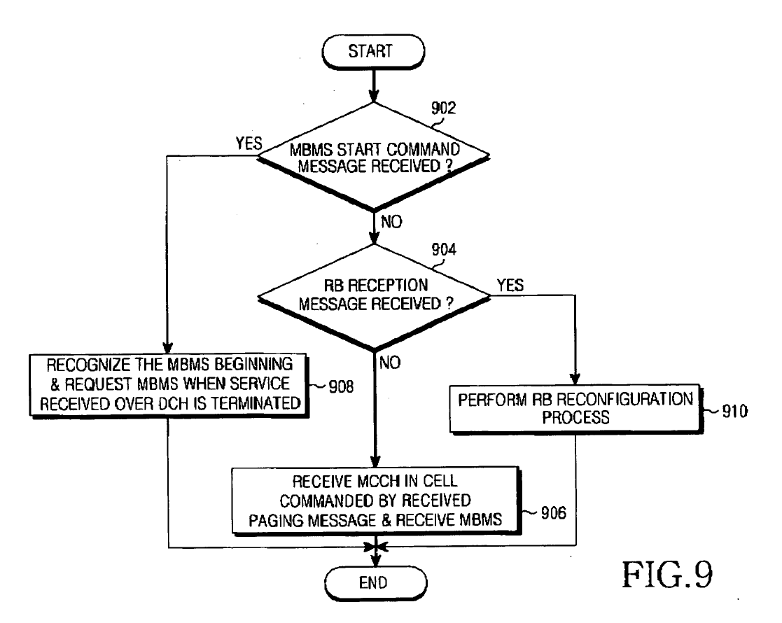

FIG. 9 is a flow chart illustrating operations of the UE in accordance with a preferred embodiment of the present invention. In FIG. 9, it is assumed that the UE communicates with a plurality of cells.

Referring to FIG. 9, the UE determines whether the third paging-type message including only the MBMS ID is received to command the beginning of the MBMS at step 902. Upon receipt of the third paging-type message indicative of the beginning of the MBMS, the UE recognizes the beginning of the MBMS, and requests the MBMS in response to the MBMS ID when a dedicated service currently received over the DCH is terminated at step 908.

Otherwise, if the UE does not receive the third paging-type message indicative of the beginning of the MBMS, it determines whether the RB reconfiguration message is received at step 904. If it is determined that the RB reconstruction message is received at step 904, the UE performs an RB reconfiguration process at step 910, and receives the MBMS through the RB.

If the UE does not receive the RB reconstruction message at step 904, it receives the third paging-type message including the MBMS ID, the cell ID, and the MCCH information, acquires control information over the MCCH in a cell commanded by the cell ID, and receives the MBMS using the acquired control information at step 906.

As apparent from the above description, the present invention transmits a third paging-type message including an MBMS ID, an ID of a cell capable of providing the MBMS, and the MCCH information transmitted from the cell over a dedicated channel (DCH). The present invention pages the UE communicating with a plurality of cells in the CELL_DCH mode using the third paging-type message, such that the UE in the CELL_DCH mode can receive the MBMS.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method for paging a User Equipment (UE) in a mobile communication system for supporting an MBMS (Multimedia Broadcast/Multicast Service), comprising the steps of:
requesting a transmission mode in response to the MBMS from at least one CRNC (Control Radio Network Controller) controlling a plurality of cells communicating with the UE, when an SRNC (Serving Radio Network Controller) for supporting the MBMS recognizes the beginning of the MBMS in which the UE is joined;
receiving MCCH (MBMS control channel) information including control information adapted to support the MBMS according to the requested result; and
transmitting a paging message including the MCCH information to the UE over a dedicated channel (DCH).

2. The method according to claim 1, wherein the paging message further includes an MBMS ID (Identifier) indicative of the MBMS and a cell ID indicative of a cell which will receive the MBMS.

3. The method according to claim 1, further comprising the step of:
controlling the UE having received the paging message to receive control channel information from the CRNC, establishing a Radio Bearer (RB) for receiving the MBMS, and receiving the MBMS data using the established RB.

4. The method according to claim 1, further comprising the step of:
controlling the UE having received the paging message including the cell ID to receive control channel information transmitted from the CRNC from the cell, establishing a Radio Bearer (RB) for reception of the MBMS, and receiving the MBMS data using the established RB.

5. A method for controlling an SRNC (Serving Radio Network Controller) providing an MBMS (Multimedia Broadcast/Multicast Service) to page a User Equipment (UE) in a mobile communication system for supporting the MBMS, comprising the steps of:
requesting a transmission mode in response to the MBMS from at least one CRNC (Control Radio Network Controller) controlling a plurality of cells communicating with the UE, when the SRNC recognizes the beginning of the MBMS;
receiving response messages including information of a transmission mode in response to the MBMS from the CRNCs; and
transmitting a paging message including control information of a control channel adapted to receive the MCCH to the UE over a dedicated channel (DCH) in consideration of the response messages.

6. The method according to claim 5, wherein the SRNC transmits the paging message further including an MBMS ID (Identifier) and a cell ID indicative of a cell supporting the MBMS.

7. The method according to claim 5, wherein the SRNC transmits the paging message to the UE over the CRNCs when receiving response messages including information of a PtM (Point-to-Multipoint) transmission mode.

8. The method according to claim 8, wherein the SRNC transmits a message including an RB (Radio Bearer) reconfiguration information supporting the MBMS to the UE when receiving response messages including information of a PtP (Point-to-Point) transmission mode.

9. The method according to claim 5, wherein the SRNC receives response messages including information of a PtP transmission mode from the CRNCs, and transmits a paging message including only an MBMS ID to the UE when the MBMS cannot be received in the SRNC in a PtP (Point-to-Point) transmission mode in consideration of MBMS reception capability of the UE.

10. A method for allowing a CRNC (Control Radio Network Controller) controlling a cell communicating with a User Equipment (UE) to support the MBMS in a mobile communication system for supporting an MBMS (Multimedia Broadcast/Multicast Service), comprising the steps of:
receiving a message requesting a transmission mode in response to the MBMS from an SRNC (Serving Radio Network Controller) supporting the MBMS when the CRNC recognizes the beginning of the MBMS;
determining a transmission mode in response to the MBMS; and
including control channel information including RB (Radio Bearer) information supporting the MBMS in a response message associated with the request message according to the determined transmission mode, and transmitting the response message including the control channel information.

11. The method according to claim 10, wherein the CRNC determines a PtM (Point-to-Multipoint) transmission mode, transmits response messages to the SRNC in the PtM transmission mode, and transmits a paging message including the control channel information transmitted from the SRNC to the UE over a dedicated channel (DCH).

12. The method according to claim 10, wherein the paging message further includes an MBMS ID (Identifier) and a cell ID indicative of a cell supporting the MBMS.

13. The method according to claim 10, wherein the CRNC determines a PtP (Point-to-Point) transmission mode, transmits response messages to the SRNC in the PtP transmission mode, and transmits a paging message including RB reconstruction information adapted to support the MBMS transmitted from the SRNC to the UE.

14. The method according to claim 10, wherein the CRNC determines a PtP (Point-to-Point) transmission mode, transmits response message to the SRNC in the PtP transmission mode, and transmits a paging message including only an MBMS ID transmitted from the SRNC to the UE.

15. A method for paging a User Equipment (UE) to receive an MBMS (Multimedia Broadcast/Multicast Service) in a mobile communication system for supporting the MBMS, comprising the steps of:
receiving a message including an MBMS ID (Identifier) indicative of the beginning of the MBMS; and
checking the received message, and receiving the MBMS in a cell using a cell ID included in a paging message when the checked message is equal to the paging message further including control channel information adapted to support the MBMS.

16. The method according to claim 15, wherein the paging message includes RB (Radio Bearer) information for supporting the MBMS in the control channel information.

17. The method according to claim 15, wherein the paging message further includes the MBMS ID.

18. The method according to claim 15, further comprising the step of:
determining, by the UE, whether the message is equal to a message including RB reconstruction information adapted to support the MBMS.

19. The method according to claim 15, further comprising the step of:
if the message is equal to a message including the MBMS ID, performing, by the UE, a joining process according to the MBMS ID when the UE terminates the MBMS provided over a dedicated channel in a current cell.
